(19) United States
(12) Patent Application Publication
(10) Pub. No.: US 2016/0378316 A1
(43) Pub. Date: Dec. 29, 2016

(54) User Interface Slider Tool For Communicating Subjective Parameters

(71) Applicant: Oliver Jakubiec, Playa Del Rey, CA (US)

(72) Inventor: Oliver Jakubiec, Playa Del Rey, CA (US)

(21) Appl. No.: 14/751,954

(22) Filed: Jun. 26, 2015

(51) Int. Cl. G06F 3/0484

(52) U.S. Cl. CPC G06F 3/04847

(57) ABSTRACT

A user interface slider tool is provided for communicating preference values for subjective parameters. The slider tool comprises a slider stem having a plurality of designated positions corresponding to preference values for a given parameter and a control handle that moves along the slider stem. A first preference value indicates the parameter is not desired, a second preference value indicates an indifference to the parameter, a third preference value indicates a minimal desire for the parameter, and a fourth preference value indicates a maximum desire for the parameter. An alternate embodiment has a flared slider stem that allows preferences for one or two additional parameters to be communicated by positioning the control handle within a flared rating area. This slider tool offers useful information to an application by providing an intuitive and easy-to-use tool with granular controls that allows for effective communication of user preferences while limiting subjective sampling variance.

### RELATED U.S. APPLICATION DATA

This application claims priority to Provisional Application No. 62/017,261, filed Jun. 26, 2014.

### FIELD OF THE INVENTION

The present invention relates to user interface (UI) tools, and in particular, UI tools for communicating subjective parameters.

### BACKGROUND

Software applications running on electronic devices, regardless of their deployment target device (websites, mobile apps, applications, etc., hereafter collectively referred to as applications), require user interface (UI) elements to dictate instructions and preferences from the user to the application. Many conventional applications attempt to express user preferences through illustrated icon ratings (e.g., an N-star rating system where N is the number of stars in the rating scale), arbitrary number scales (e.g., a 1-to-N scale, where N is the last number in the scale, as in a 1-to-10 scale), survey questions, multi-page wizards or modals, etc. However, as the interfaces are simplified, accuracy tends to suffer from sampling errors caused by subjective interpretation of the perceived value of each increment on the scale. This error is amplified when dealing with a population of users, such as in star rating systems or number scale systems. For example, while one user may rate a “good” product as 4-out-of-5 stars on a star rating system, or an 8-out-of-10 on a number scale rating system, another user with an identical “good” feeling regarding the product may rate the same product as a 3-star, or 6-out-of-10 product due to their subjective assessment of granularity of the scale. The error introduced due to subjectivity regarding the scale itself is further compounded when numerous parameters are gathered to generate an appropriate result (e.g. generating a list of suitable product(s) based on user-selected criteria).

Furthermore, as conventional interfaces increase in complexity, such as interfaces with survey questions or multi-page wizards, the UI complexity makes the selection process progressively more time-consuming and more cumbersome for the user, while not necessarily improving the accuracy of the input or the results. Tools that allow a user to both quickly and accurately express their subjective preferences about a product or parameter are useful when designing software that is responsive to the user's subjective preferences. Thus, there is a need for improved UI tools having greater ease of use and more accurate user assessment.

### SUMMARY OF THE INVENTION

The present invention provides a novel user interface (UI) tool in the form of a slider control for communicating one or more subjective parameters. Disclosed embodiments include a slider control composed of a specialized set of subdivisions on the slider stem and control handle positional stepping that confines user feedback to a binary response for the first two control handle positions on the slider (signifying either a plenary indifference or a plenary negative preference), and allows for one-dimensional or two-dimensional control handle positioning once the control handle passes the plenary indifference (“Off”) position on the slider axis. Alternate embodiments disclose the unique segmentation of the control handle positions, including optional tolerances for providing visual feedback to the user via changes in color, size, shape, and images of the tool components, allowing for detailed and consistent descriptions of subjective user preferences to be communicated to underlying applications for processing. As described, a slider tool is provided that provides useful information to an application, with discrete granular controls that helps limit subjective sampling variance inherent whenever profiling subjective preferences, all while remaining intuitive and simple-to-use for the end user.

### BRIEF DESCRIPTION OF THE DRAWINGS

FIG. 1 illustrates a Guillotine embodiment oriented at 0° with exactly 4 preference value positions on the slider stem.

FIG. 2 illustrates a Guillotine embodiment oriented at 0° with exactly 5 labeled slider stem positions.

FIG. 3 illustrates a Guillotine embodiment oriented at 0° with exactly 4 labeled slider stem positions, with the control handle in various positions along the slider axis.

FIG. 4 illustrates a Cocktail embodiment oriented at 0° with exactly 4 labeled slider stem positions.

FIG. 5 illustrates a Cocktail embodiment oriented at 0° with exactly 5 labeled slider stem positions.

FIG. 6 illustrates a Cocktail embodiment oriented at 0° with exactly 4 labeled slider stem positions, with the control handle in various positions on the slider axis and flare of the slider stem, including conceptual reactions of the interface to changes in the control handle position.

FIG. 7 illustrates a Guillotine embodiment with exactly 4 labeled slider stem positions oriented at various rotations, including 0°, 180°, −90°, and +90°.

FIG. 8 illustrates a composite application with more than one slider embodiment oriented at 0° with exactly 4 labeled slider stem positions, illustrating how an unlimited number of sliders may be combined in unison to create an extensible and adaptive UI.

FIG. 9 is an illustration of a process of implementing slider tools in an application.

FIG. 10 illustrates an alternate half-Cocktail embodiment of the slider tool for rating two parameters.

### DETAILED DESCRIPTION

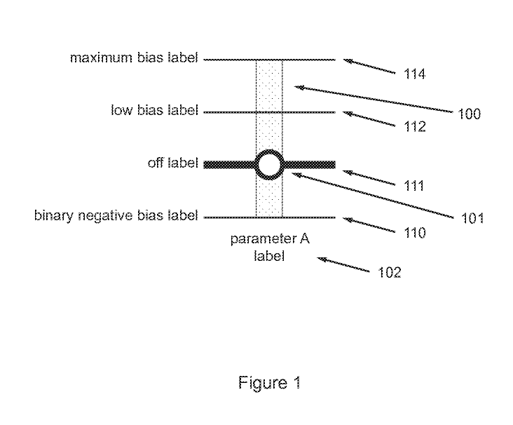

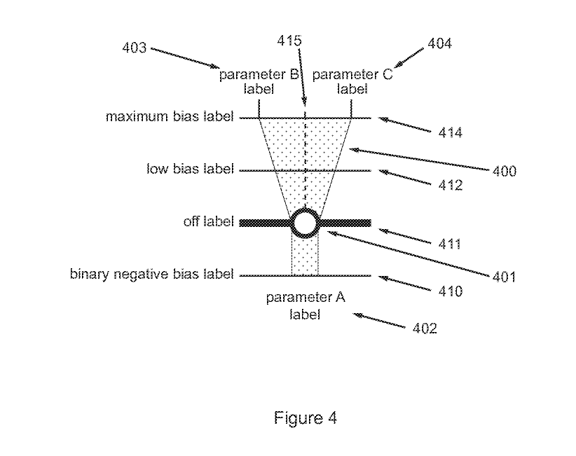

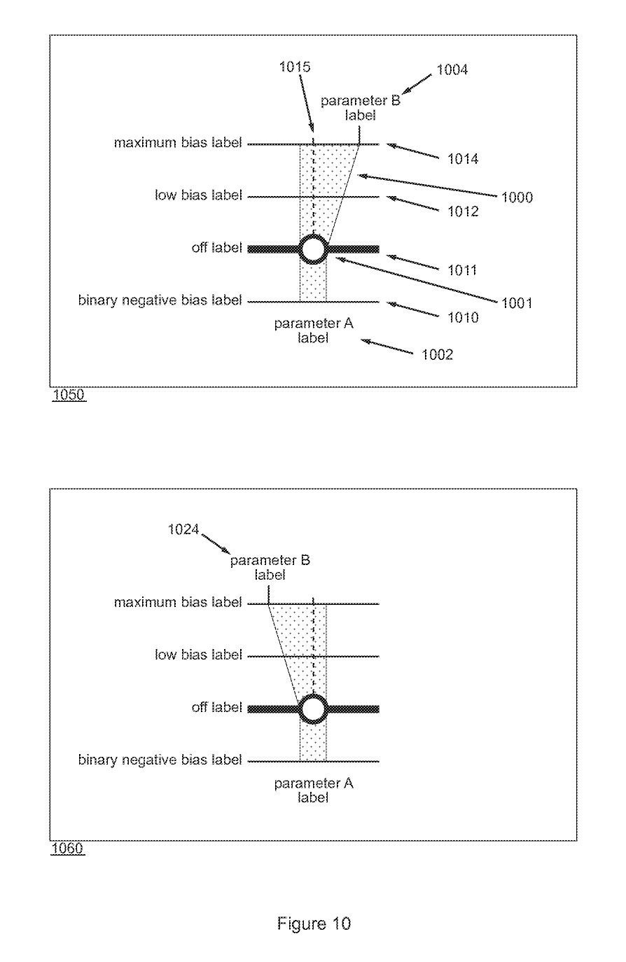

The present invention provides a user interface (UI) tool for communicating or rating a user preference for one or more parameters. For the purpose of illustration, as shown in FIGS. 1-3, an exemplary embodiment of the user interface (UI) slider tool comprises a one-dimensional slider (hereafter referred to as a “Guillotine” slider, due to its shape). In one embodiment, a “Guillotine” slider has four or five designated labeled positions along the slider stem corresponding to subjective or qualitative preference values or ratings (i.e., negative bias, neutral bias, and two or three levels of positive bias). An alternate embodiment shown in FIGS. 4-6 features a two-dimensional slider (hereafter referred to as a “Cocktail” slider, due to its shape) for rating user preferences for three parameters. Like the Guillotine embodiment, the Cocktail slider may have either four or five slider stem labels corresponding to values for that criteria or parameter (i.e. “Don't want any” (binary negative bias), “Doesn't matter to me” (Off), “Some” (Low Bias), and “Plenty” (Maximum Bias)). Exactly one preference value position exists below the axis signifying a “do not want any” (i.e. a binary negative bias) of the parameter. In this embodiment the user expresses a positive bias above the “Off” axis, with two or more preference value positions above the axis, with either stepped or continuous values returned for positions between the “Off” axis and the “Maximum Bias” axis. A “half-Cocktail” embodiment is provided in FIG. 10 for rating user preferences for two parameters. The slider tool can also include a color, size, shape, and/or image feedback on either or both the slider stem and the control handle, which may change with different preference value positions on the slider stem. Conventional criteria selection tools use a star rating system (3, 4, 5-star, etc.), or number rating system (1-5, 1-10, etc.). Those scales transfer very poorly from one user to another because they are implicitly vague. The slider tools of the present invention are visually and qualitatively intuitive and translate to more accurate expression of user preference. The slider stem stepped values significantly reduce the subjective variance, or error of intent, from user-to-user.

Referring to FIG. 1, the Guillotine slider tool comprised of a slider stem 100 having four labeled positions corresponding to preference values, i.e. Binary Negative Bias label 110, Off label 111, Low Bias label 112, and Maximum Bias label 114. As used herein, the terms “labeled positions” or “position labels” refer to, and may be used interchangeably with, the “preference value” or “preference rating.” These labeled positions refer to the value that the user can assign to express or communicate the preference for the given parameter (e.g., sweetness, orange flavor, jasmine scent) and are referred to as “values” or “ratings” of the parameter. In this example, the parameter label 102 is “parameter A.” The control handle 101 moves along the slider stem 100. The control handle 101, as well as the parameter label 102, may be comprised of text, image or animation. As shown, the control handle 101 is at the “Off” position 111. In the “Off” position 111, the slider has no influence on the decision, i.e. the user is totally indifferent to the presence or absence of the given parameter being rated (parameter 102). When the control handle is in the negative bias position 110, it means that the user explicitly does not want any of parameter 102. Conversely, the positive bias positions, i.e. Low Bias 112 and Maximum Bias 114, indicate varying levels of parameter 102 that is desired by the user.

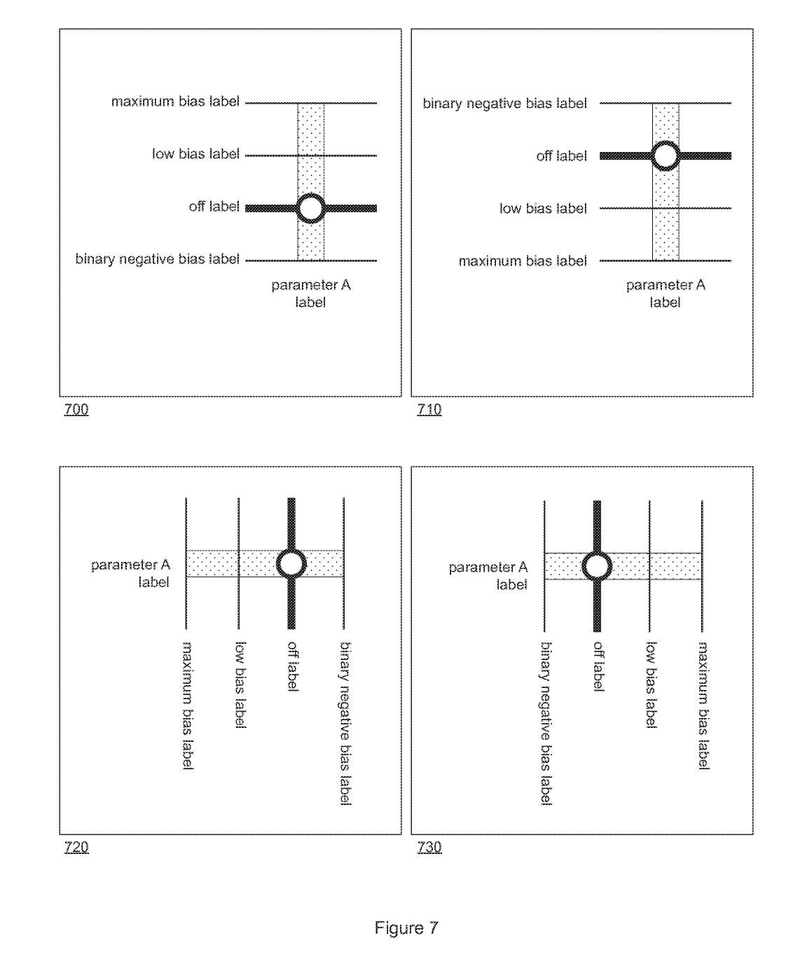

The specific wording of the preference values can be customize as desired. For example, the four preference values could be: “None” (corresponding to Binary Negative Bias 110), “I Don't Care” (corresponding to Off 111), “Some” (corresponding to Low Bias 112), and “Plenty” (corresponding to Maximum Bias 114). The slider tool is oriented at 0° but can be rotated (e.g., as shown in FIG. 7). By combining the ability to survey multiple crucial aspects of subjective user preferences—including a user's indifference, a user's binary negative desire, and a narrowly constrained representation of a user's positive bias—all in a single interface that both limits scale interpretation errors while being efficient to use, the invention allows users an improved ability to rapidly express their desired product characteristics. Product characteristics (or parameters) may include, for example, color, flavor, texture, or scent.

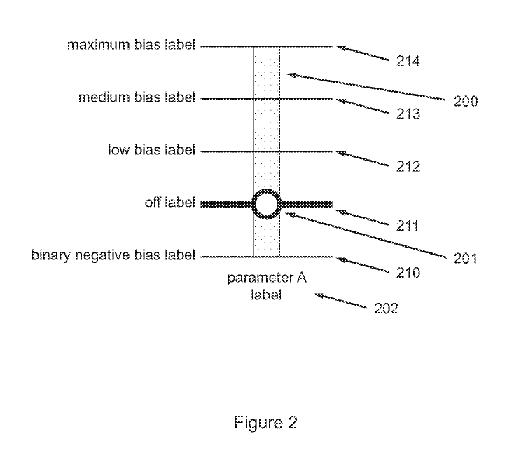

FIG. 2 depicts a Guillotine slider tool, similar to that of FIG. 1, oriented at 0° but with a slider stem 200 having five preference value positions, i.e. Binary Negative Bias 210, Off 211, Low Bias 212, Medium Bias 213, and Maximum Bias 214. The slider tool also comprises a parameter label 202 that signifies the parameter that is being rated or measured by the user, in this case “parameter A.” As shown, the control handle 201 is at the Off position 211. In the “Off” position 211, the slider has no influence on the decision, i.e. the user is totally indifferent to the presence or absence of the given parameter A. When the control handle is in the negative bias position 210, it means that the user explicitly does not want any of parameter A. Conversely, the positive bias positions, i.e. Low Bias 212, Medium Bias 213, and Maximum Bias 214, indicate varying levels of parameter A that are desired by the user. The slider tool of FIG. 2 is different from that of FIG. 1 in that it has an additional parameter value position, i.e. Medium Bias label 213. While additional parameter value positions could be added, the usefulness of the slider tool diminishes as the user's intent becomes more vague and leads to greater error in assessing intent and higher variances among sample populations. For example, a sixth value position can be included corresponding to a Medium Low Bias value that is located between the Low Bias position and the Medium Bias position on the slider stem 200.

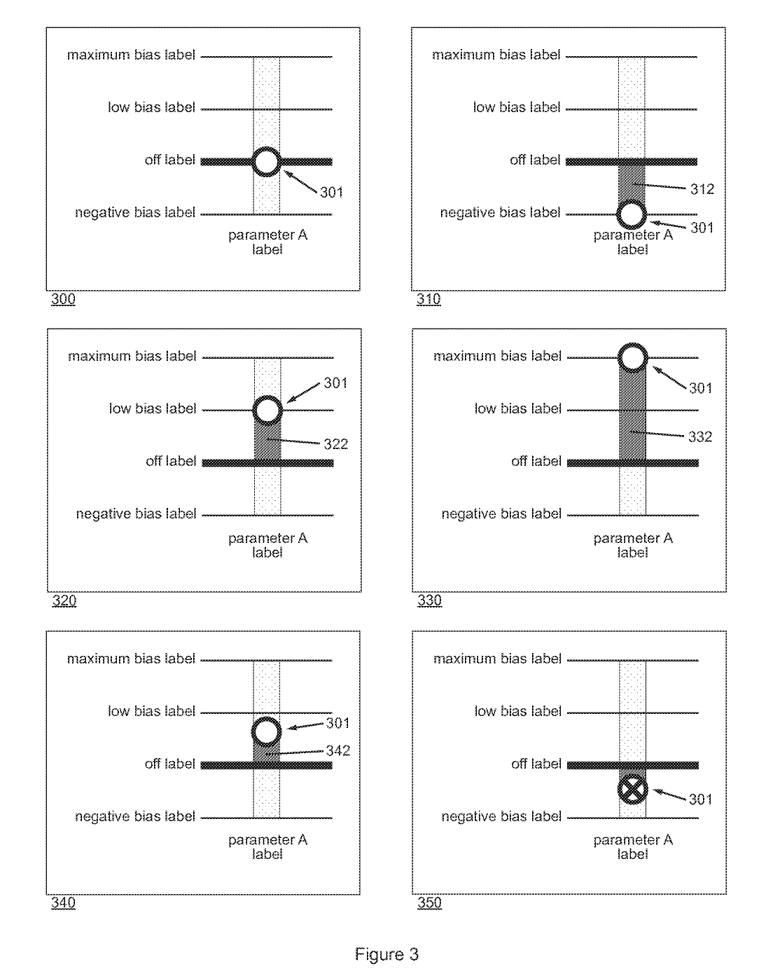

FIG. 3 illustrates the slider tool of FIG. 1 with the control handle 301 in various positions along the slider stem. In configuration 300, the control handle 301 is in the Off position, in configuration 310 the control handle is in the negative bias position, in configuration 320 the control handle is in the Low Bias position, in configuration 330 the control handle is in the Maximum Bias position, in configuration 340 the control handle is in between the Off and Low Bias positions, and in configuration 350 the control handle is in between the Off position and negative bias position. The shaded areas 312, 322, 332, and 342 on the slider stems in configurations 310, 320, 330, and 340, respectively, indicate that the stem may be filled with a color, pattern, or images, providing visual feedback to the user as to the intensity (or lack of intensity) with which Parameter A 302 is being applied. The slider tool of the present invention can be continuous or stepped with respect to the positive bias range (i.e., above the Off position as in configurations 320, 330, and 340). That is, in a continuous embodiment, the control handle can be placed at any point along the positive bias range slider stem (i.e., on or anywhere in between the designated preference value positions). In the stepped embodiment, however, the control handle can only be placed on the designated preference values (i.e., labeled positions).

For example, referring to configuration 340, in a stepped configuration the placement of the control handle on the slider stem will cause the control handle to automatically jump to the nearest preference value when it is released by the user, i.e. releasing the control handle in configuration 340 in a stepped configuration will result in the control handle jumping to the Low Bias position as in configuration 320, because in the stepped embodiment the control handle can only reside on the designated preference value positions. Whereas in the continuous slider tool embodiment, when the control handle is move to, and released at, the position shown in configuration 340, it remains there. However, the Negative Bias position is stepped in all embodiments, such that the negative bias rating is always absolute (i.e., there is no “partial” Off rating). For example, referring to configuration 350, the control handle has been placed in an invalid position that is approximately 40% of the way between the Off position and the Negative Bias position. If the control handle is released by the user at the position in configuration 350, the control handle will automatically jump to the nearest designated rating position, which in this case is the Off position (as in configuration 300). Thus, the Off position and the Negative Bias position have a binary relationship such that the control handle cannot be placed anywhere in between them on the slider stem.

FIG. 4 illustrates an alternate “Cocktail” embodiment of the slider tool oriented at 0° with four preference value positions along the slider stem. The “Cocktail” embodiment features the same functionality of the “Guillotine” slider but with a modified structure that allows for more complex information to be conveyed in the positive bias area of the slider stem. A vertical centerline 415 runs down the center of the slider stem 400. The centerline 415 is provided by way of reference, and is not necessarily a visual element of the slider tool. The positive bias area (the portion of the slider stem above the Off position) is flared in the negative and positive X-axis (horizontal axis) as illustrated to allow a secondary decision axis. In this case, a flared area (i.e. “flared rating area”) is formed by the left and right sides of the slider stem that diverge or flare away from the centerline 415 starting at the Off position until reaching the Maximum Bias position. Changes to the control handle position along the X-axis changes preference values for parameter A in either a continuous (allowing an infinite number of X-axis positions) or stepped (discrete X-axis positions) manner. For example, where parameter A is “Berry,” a −X control handle position (to the left of the centerline 415), could augment the value preference from any type of “Berry” toward a bias for “BlackBerry”, while a +X control handle position (to the right of the centerline 415) could augment the value preference from any type of “Berry” toward a bias for “Strawberry”, with the centerline 415 position as a neutral bias for any type of “Berry”, which includes both “Blackberry” and “Strawberry.” Additionally, the slider tool can include color or image feedback on the stem that may also change as the control handle is moved in the X (horizontal) and Y (vertical) directions. Color, size, shape, and image feedback on the control handle itself also may change as the control handle is moved in the X (horizontal) and Y (vertical) directions.

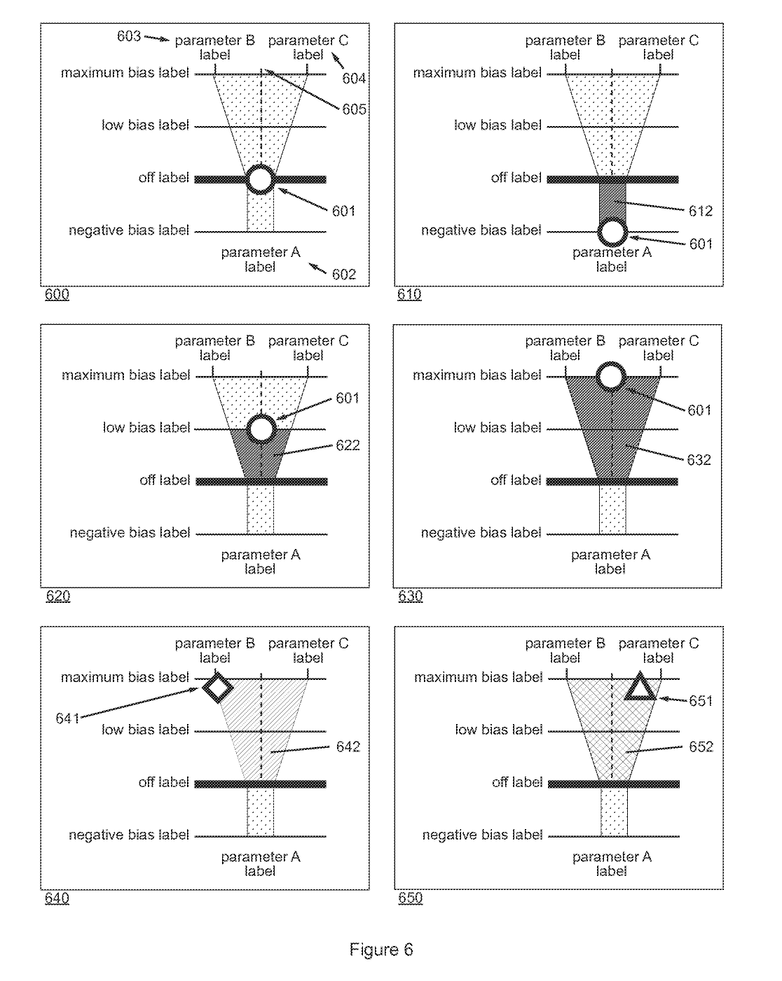

As shown, the slider stem flares into a two-dimensional area (i.e. the “flared rating area”) to allow two additional parameters to be rated, i.e. Parameter 403 (Parameter B) and Parameter 404 (Parameter C). Thus, this slider tool allows three parameters to be rated, i.e. Parameters A, B and C. For example, in a perfume application, Parameter A could be for rating the citrus intensity in the perfume, while Parameter B could bias the user's preference toward lemons and Parameter C could bias the user's preference towards oranges. The slider tool is comprised of a slider stem 400 having four labeled positions, i.e. Binary Negative Bias 410, Off 411, Low Bias 412, and Maximum Bias 414. As described above, these labeled positions refer to the preference value or rating that the user can assign to the given Parameter A (i.e., parameter 402). The specific wording of the preference values can be customize as desired. For example, the four labeled value positions (i.e., preference values) could be: “None” (corresponding to Binary Negative Bias 410), “I Don't Care” (corresponding to Off 411), “Some” (corresponding to Low Bias 412), and “Plenty” (corresponding to Maximum Bias 414). The control handle 401 moves along the slider stem 400. The control handle 401, as well as the parameter label 402, may be comprised of text, image or animation. As shown, the control handle 401 is at the Off position 411. The slider tool is oriented at 0° but can be rotated (e.g., as shown in FIG. 7). Exemplary preference values, as determined by the control handle position, are shown in FIG. 6.

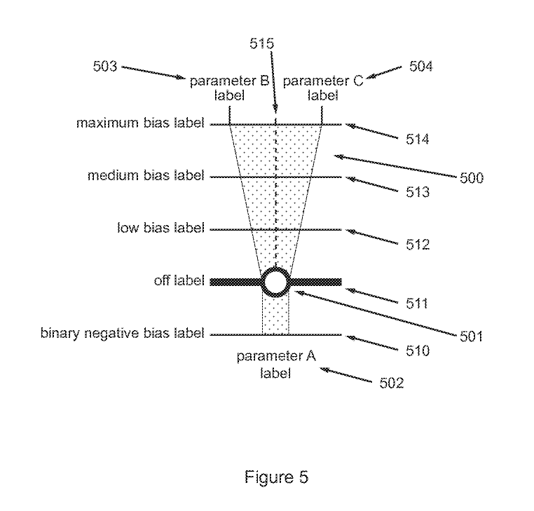

FIG. 5 conceptually illustrates a Cocktail embodiment of the slider tool oriented at 0° with exactly five labeled slider stem positions. The slider tool of FIG. 5 is different from that of FIG. 4 in that it has an additional preference value position, i.e. Medium Bias label 513. As with the embodiment of FIG. 4, the slider stem flares into a two-dimensional area (i.e. “flared rating area”) to allow two additional parameters beyond parameter 502 (Parameter A) to be rated, i.e. parameter 503 (Parameter B) and parameter 504 (Parameter C). Thus, this slider tool allows three parameters to be rated, i.e. Parameter A, Parameter B, and Parameter C. The slider tool is comprised of a slider stem 500 having five preference value positions, i.e. Binary Negative Bias 510, Off 511, Low Bias 512, Medium Bias 513, and Maximum Bias 514. These preference values refer to the rating that the user can assign to the given Parameter A (i.e., parameter 502). The control handle 501 moves along the slider stem 500. The control handle 501, as well as the parameter A, may be comprised of text, image or animation. As shown, the control handle 501 is at the Off position 511. The slider tool is oriented at 0° but can be rotated (e.g., as shown in FIG. 7).

FIG. 6 illustrates the Cocktail embodiment of the slider tool oriented at 0° with exactly four preference value positions along the slider stem (as shown in FIG. 4), with the control handle in various preference value configurations. FIG. 6 illustrates exemplary reactions of the slider tool in response to various control handle positions. In configuration 600, the control handle 601 is in the Off label position, i.e. parameters A, B and C are all in the Off position. Centerline 605 runs vertically through the center of the slider stem and intersects the center of the horizontal axis between parameters B and C, indicating that Parameter A is unaffected by any bias from Parameter B or C when the control handle is aligned in this X-position (i.e., a neutral center bias). To the left of the top of centerline 605 is the positive bias label 603 for Parameter B, and to the right of the top of centerline 605 is the positive bias label 604 for Parameter C. In configuration 610, the control handle 601 is in the negative bias position, and the bias of parameters B and C is disregarded. As noted above, the centerline 415 is provided as a spatial reference point, and is not necessarily a visual element of the slider tool.

When the control handle is horizontally centered on the stem, i.e. aligned with the centerline 605 as shown in configurations 600, 610, 620, and 630, only Parameter A is in effect without any bias for Parameter B or Parameter C. This means that the Cocktail slider behaves just like the Guillotine slider, indicating the user's preference for Parameter A. If the user moves the control handle to the left or right (toward the flared sides of the slider stem), then a “bias” for Parameter B or Parameter C is applied to Parameter A. For example, moving the control handle to the left indicates that the slider is now biased to represent more of Parameter B (as in configuration 640) and moving the control handle to the right indicates that the slider is now biased to represent more of Parameter C (as in configuration 650). The diamond-shaped element 641 is the same UI control handle 601 but indicates that the control handle itself may change to another shape, color, imagery, or animation as the control handle is moved left toward Parameter B. The triangle-shaped element 651 is the same UI control handle 601 but indicates that the control handle itself may change to yet another different shape, color, imagery, or animation as the control handle is moved right toward Parameter C.

For the purpose of the following example illustrating the operation of the slider tool of FIG. 6, it can be assumed that Parameter A is “Berry”, Parameter B is “Blackberry”, and Parameter C is “Strawberry.” Parameter A (Berry) encompasses Parameters B (Blackberry) and C (Strawberry) since these are both types of berry. If the user moves the control handle vertically only (as in configurations 620 and 630), it will indicate a preference for any kind of berry (including Blackberry and Strawberry). If the user pulls the handle to the left of center (as in configuration 640), it indicates that they want plenty of Berry, with a specific bias to Blackberry. As such configurations 620 and 630 each indicate a desire for some kind of berry, with 630 indicating a desire for “more berry” than in 620. If the user pulls the handle to the right of center (as in configuration 650), it indicates that they want plenty of Strawberry, specifically. Parameter B and Parameter C are related to Parameter A, in that they are all berries, but this slider tool makes inputting nuanced preferences much more efficient and visually accessible to the user.

In configuration 610, the shaded area 612 indicates that the slider stem may be filled with a color, pattern, or images, providing visual feedback to the user as to the intensity (or lack of intensity) with which Parameter A is being applied. In configuration 620, the shaded area 622 indicates that the slider stem may be filled with a color, pattern, or images indicating that the slider contains a Low Bias of Parameter A. In configuration 630, the shaded area 632 indicates that the slider stem may be filled with a color, pattern, or images indicating that the slider contains a Maximum Bias of Parameter A. In configuration 640, the shaded area 642 indicates that the slider stem may be filled with a color, pattern, or images indicating that the slider contains a Maximum Bias of Parameter A with a positive bias toward Parameter B. In configuration 650, the shaded area 652 indicates that the slider stem may be filled with a color, pattern, or images indicating that the slider contains a Maximum Bias of Parameter A with a positive bias toward Parameter C.

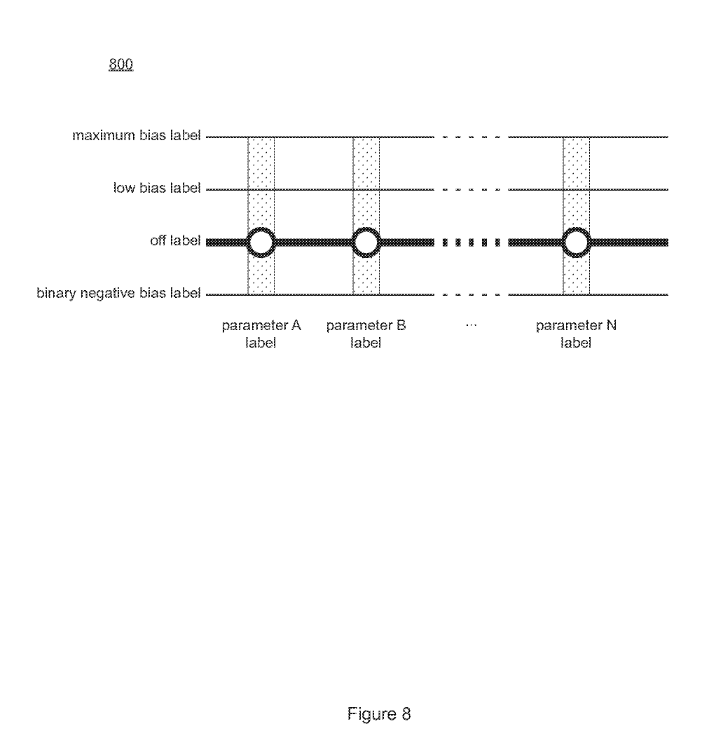

The orientation of the slider can be at any angle (360-degree rotation). For example, the slider can be inverted such that up can be a negative bias and down can be a positive bias. Similarly, the slider can be rotated 90-degrees such that sliding to the left is a negative bias and right is a positive bias. FIG. 7 illustrates a Guillotine embodiment with four preference value positions (as shown in FIG. 1) oriented at various rotations, namely 0° (configuration 700), 180° (configuration 710), −90° (configuration 720), and +90° (configuration 730). FIG. 8 illustrates a composite application having a plurality of slider tools in parallel and oriented at 0° with four preference value positions. This illustrates how a plurality of slider tools may be combined in unison to create an extensible and adaptive user interface (UI) to rate a corresponding plurality of parameters (i.e. parameters A, B . . . N).

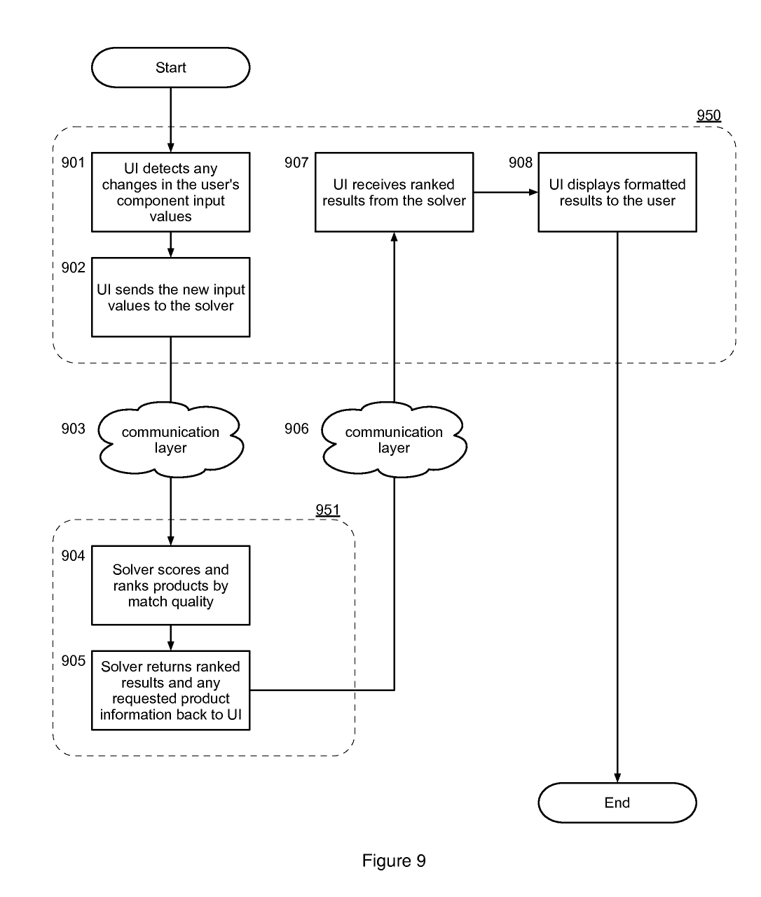

FIG. 9 illustrates a process of implementing slider tools in an application. As shown, steps 901, 902, 907 and 908 occur on a User Interface (UI) 950. Steps 904 and 905 occur on a solver 951, which can reside anywhere that the calculations are done, which can be the target device, a web server, or other location. The job of the solver 951 is to process the inputs from the sliders and calculate how the positions of each of the control handles affect the result set. The solver then passes the results back to the UI so that results may be displayed. Additionally, the solver may store information regarding the use of the sliders. At a first step 901, the user interface (UI) detects any changes in the user's parameter input values (i.e. parameter rating values). Next, at step 902 the UI sends the new input values to the solver 951. At step 903, the input values are sent to the communication layer, which transports the input data to the solver (e.g., the Internet, local network, wireless, etc.). At step 904, the solver scores and ranks products by match quality and at step 905 the solver returns ranked results and any other requested information back to the UI. The information is then transmitted from the solver 951, through the communications layer 906, and back to the UI 950. At step 907 the UI receives the ranked results from the solver 951. At step 908 the UI displays information based on the results provided by the solver back to the user (e.g., an ordered list of products by best match, or worst match, or other sorting criteria). The communication layers 903 and 906 comprise any type of communication technology, such as the Internet (e.g., HTTP, HTTPS, or other protocols), local networks, internal to the device (e.g. kiosk, laptop, or other digital devices), wireless networks, etc. Thus, as described, the process of FIG. 9 illustrates one configuration in which the UI tool (front end) can work with an API server (back end).

FIG. 10 illustrates an alternate “half-Cocktail” embodiment of the slider tool for rating two parameters A and B. This embodiment is similar to the Cocktail embodiment of FIG. 4 except that one side of the Cocktail's flared area (i.e., the “flared rating area”) is removed along with the associated parameter. Parameter label 1002 indicates that the preference for Parameter A is being rated. A centerline 1015 runs vertically through the center of the slider stem 1000. The positive bias area on the slider stem (above the OFF position) is flared to the right (positive X-axis direction) to provide a secondary decision axis for rating parameter B. Changes to the control handle 1001 position along the X-axis changes slider parameter results in either a continuous (allowing an infinite number of X-axis positions) or stepped (discrete X-axis positions) manner toward a new bias. For example, on a slider tool that controls a “Berry” for Parameter A, a +X control handle position could augment the slider parameter from any type of “Berry” toward a bias for “Strawberry”, with the Center-X position as a neutral bias for any type of “Berry”, which includes “Strawberry.” Additionally, the slider tool can include color and image feedback on the stem that may also change as the control handle is moved in the X and Y directions. Color, size, shape, and image feedback on the control handle itself also may change as the control handle is moved in the X (horizontal) and Y (vertical) directions.

Referring to configuration 1050, the slider stem diverges or flares to the right to form a two-dimensional area (“flared rating area”) to allow an additional parameter to be rated, i.e. parameter 1004 (Parameter B) along with parameter 1002 (Parameter A). Thus, this slider tool allows two parameters to be rated, i.e. Parameter A and Parameter B. For example, in a perfume application, Parameter A could represent the citrus intensity in the perfume, while Parameter B could bias the user's preference toward lemons. The slider tool is comprised of a slider stem 1000 having four preference value positions, i.e. Binary Negative Bias 1010, Off 1011, Low Bias 1012, and Maximum Bias 1014. These labeled positions refer to the value or rating that the user can assign to the given Parameter A (i.e., parameter 1002). However, these exemplary preference values are merely representative, and the values can be expressed in a variety of other ways as desired for the particular application. For example, the four preference values could be: “None” (corresponding to Binary Negative Bias), “I Don't Care” (corresponding to Off), “Some” (corresponding to Low Bias), and “Plenty” (corresponding to Maximum Bias). The control handle 1001 moves along the slider stem 1000. The control handle 1001, as well as the parameter A label, may be comprised of text, image or animation. The centerline 1015 passes through the center of the slider stem 1000. As shown, the control handle 1001 is at the Off position 1011. By way of example, the positioning of the control handle at point B (i.e. intersection of the flared portion and Maximum Bias position 1014) indicates a Maximum Bias for Parameter A and a positive bias for Parameter B. The positioning of the control handle at the intersection of the centerline 1015 and the Low Bias position 1012 indicates a Low Bias for Parameter A but an indifference to Parameter B. The positioning of the control handle at the intersection of the Low Bias position 1012 and the flared portion indicates a Low Bias for Parameter A and a positive bias for Parameter B.

The slider tool can also include a fifth value position for Parameter A corresponding to a Medium Bias value located between the Low Bias position and the Maximum Bias position on the slider stem 1000 (as shown in FIG. 5). Similarly, a sixth value position can be included corresponding to a Medium Low Bias value that is located between the Low Bias position and the Medium Bias position on the slider stem 1000. As with the other described embodiments, the control handle 1001 can operate in either a stepped or continuous manner. In a stepped configuration, the control handle 1001 can only reside on one of the four preference value positions for Parameter A, such that release of the control handle in between those positions will cause the control handle to jump to the nearest value position. For example, if the control handle 1001 is release two-thirds of the way from the Off position to the Low Bias position, the control handle 1001 will jump to the Low Bias position. In a continuous configuration, the control handle can reside at any point along the slider stem, and release of the control handle at any point along the slider stem will cause the control handle to remain at that point. As described in connection with FIG. 6, the shape, size, color, or images of the control handle can change in response to movement of the control handle along the slider stem. Similarly, the slider stem can change color or become filled with a pattern or images in response to movement of the control handle along the slider stem. As shown, the slider tool is oriented at 0° but can be rotated (e.g., as shown in FIG. 7). Configuration 1060 is merely a mirrored version of configuration 1050, i.e. the slider stem flares to the left instead of right. Beyond a visual preference for one or the other, these configurations are functionally identical.

While there have been described herein what are considered to be preferred and exemplary embodiments of the present invention, other modifications of the invention shall be apparent to those skilled in the art from the teachings herein. For example, the relative dimensions of the device may be altered while keeping within the spirit and teachings of the invention. It is therefore desired to be secured, in the appended claims, all such modifications as fall within the spirit and scope of the invention. It is noted that the embodiments disclosed are illustrative rather than limiting in nature and that a wide range of variations, modifications, changes, substitutions are contemplated in the foregoing disclosure and, in some instances, some features of the present invention may be employed without a corresponding use of other features. Many such variations and modifications may be considered desirable by those skilled in the art based upon a review of the foregoing description of preferred embodiments. Accordingly, it is appropriate that the appended claims be construed broadly and in a manner consistent with the scope of the invention.

What is claimed is:

1. A user interface slider tool for rating a parameter comprising:
a linear slider stem having four designated positions each corresponding to a preference value for a given parameter;
a control handle that moves along the slider stem; and
wherein a first preference value indicates the parameter is not desired, a second preference value indicates an indifference to the parameter, a third preference value indicates a minimal desire for the parameter, and a fourth preference value indicates a maximum desire for the parameter.

2. The slider tool of claim 1 further comprising additional slider stems connected in parallel, each of said additional slider stems having a control handle and being uniquely associated with a parameter, wherein the slider tool is thereby able to communicate user preferences for a plurality of independent parameters.

3. The slider tool of claim 1 wherein the four preference values are: Negative Bias, Off, Low Bias, and Maximum Bias.

4. The slider tool of claim 1 further comprising a fifth value position corresponding to a Medium Bias value, said Medium Bias value position located between the Low Bias position and the Maximum Bias position on the slider stem.

5. The slider tool of claim 1 further comprising a sixth value position corresponding to a Medium Low Bias value, said Medium Low Bias value position located between the Low Bias position and the Medium Bias position on the slider stem.

6. The slider tool of claim 1 wherein the control handle can only reside on one of the four designated positions, and release of the control handle in between labeled positions will cause the control handle to jump to the nearest labeled position.

7. The slider tool of claim 1 wherein the control handle can reside at any point along the slider stem, and release of the control handle at any point along the slider stem will cause the control handle to remain at that point.

8. The slider tool of claim 1 wherein the shape, size, color, or images of the control handle changes in response to movement of the control handle along the slider stem.

9. The slider tool of claim 1 wherein the slider stem changes color, is filled with a pattern, or images in response to movement of the control handle along the slider stem.

10. A user interface slider tool for rating three parameters comprising:
a flared slider stem having four designated positions that each correspond to a different preference value for a Parameter A, the slider stem further comprising a base portion, a left flare, a right flare, a flared rating area formed by the left flare and right flare, and a centerline that passes through the center of the base portion and the flared rating area;
wherein a first value position indicates that Parameter A is not desired, a second value position indicates an indifference to Parameter A, a third value position indicates a minimal desire for Parameter A, and a fourth value position indicates a maximum desire for Parameter A;
a control handle that moves along the slider stem;
a Parameter B associated with the left flare of the slider stem, wherein a point B is designated at the intersection of the Maximum Bias position and the left flare, and wherein movement of the control handle from the centerline towards the left flare indicates a desire for Parameter B;
a Parameter C associated with the right flare of the slider stem, wherein a point C is designated at the intersection of the Maximum Bias position and the right flare, and wherein movement of the control handle from the centerline towards the right flare indicates a desire for Parameter C; and
wherein placement of the control handle on the centerline indicates an indifference to Parameter B and Parameter C.

11. The slider tool of claim 10 wherein the four preference values are: Negative Bias, Off, Low Bias, and Maximum Bias.

12. The slider tool of claim 10 further comprising a fifth value position for Parameter A corresponding to a Medium Bias value, said Medium Bias value position located between the Low Bias position and the Maximum Bias position on the slider stem.

13. The slider tool of claim 10 further comprising a sixth value position corresponding to a Medium Low Bias value, said Medium Low Bias value position located between the Low Bias position and the Medium Bias position on the slider stem.

14. The slider tool of claim 10 wherein the control handle can only reside on one of the four value positions for Parameter A, and release of the control handle in between those positions will cause the control handle to jump to the nearest value position.

15. The slider tool of claim 10 wherein the control handle can reside at any point along the slider stem, and release of the control handle at any point along the slider stem will cause the control handle to remain at that point.

16. The slider tool of claim 10 wherein the shape, size, color, or images of the control handle changes in response to movement of the control handle along the slider stem.

17. The slider tool of claim 10 wherein the slider stem changes color, is filled with a pattern, or images in response to movement of the control handle along the slider stem.

18. The slider tool of claim 10 wherein the positioning of the control handle at point B indicates a Maximum Bias for Parameter A and a bias for Parameter B.

19. The slider tool of claim 10 wherein the positioning of the control handle at point C indicates a Maximum Bias for Parameter A and a bias for Parameter C.

20. A user interface slider tool for rating two parameters comprising:
a slider stem having four value positions that each correspond to a different value for a Parameter A, the slider stem further comprising a centerline and a flared portion that extends from the centerline to either the left or right, and a rating area formed by the flared portion and the centerline;
wherein a first value position indicates that Parameter A is not desired, a second value position indicates an indifference to Parameter A, a third value position indicates a desire for Parameter A, and a fourth value position indicates a greater desire for Parameter A;
a control handle that moves along the slider stem; and
a Parameter B associated with the flared portion of the slider stem, wherein a point B is designated at the intersection of the Maximum Bias position and the flared portion, and wherein movement of the control handle from the centerline towards the flared portion indicates a desire for Parameter B.

21. The slider tool of claim 20 wherein the four preference values are: Negative Bias, Off, Low Bias, and Maximum Bias.

22. The slider tool of claim 20 further comprising a fifth value position for Parameter A corresponding to a Medium Bias value, said Medium Bias value position located between the Low Bias position and the Maximum Bias position on the slider stem.

23. The slider tool of claim 20 further comprising a sixth value position corresponding to a Medium Low Bias value, said Medium Low Bias value position located between the Low Bias position and the Medium Bias position on the slider stem.

24. The slider tool of claim 20 wherein the control handle can only reside on one of the four value positions for Parameter A, and release of the control handle in between those positions will cause the control handle to jump to the nearest value position.

25. The slider tool of claim 20 wherein the control handle can reside at any point along the slider stem, and release of the control handle at any point along the slider stem will cause the control handle to remain at that point.

26. The slider tool of claim 20 wherein the shape, size, color, or images of the control handle changes in response to movement of the control handle along the slider stem.

27. The slider tool of claim 20 wherein the slider stem changes color, is filled with a pattern, or images in response to movement of the control handle along the slider stem.

28. The slider tool of claim 20 wherein the positioning of the control handle at point B indicates a Maximum Bias for Parameter A and a bias for Parameter B.
